(19) United States
(12) Patent Application Publication
(10) Pub. No.: US 2006/0216089 A1
(43) Pub. Date: Sep. 28, 2006

(54) Image forming apparatus

(75) Inventors: Takuo Matsumura, Kanagawa (JP); Hiroyuki Ikeuchi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/213,983

(22) Filed: Aug. 30, 2005

(30) Foreign Application Priority Data
Mar. 25, 2005 (JP) P2005-088558

(51) Int. Cl. G03G 15/00

(52) U.S. Cl. 399/391; 399/392

(57) ABSTRACT

An image forming apparatus includes a sheet feeding unit, a manual sheet feeding unit, an image forming unit, first and second sheet conveyance paths, and an air-blowing unit. The first sheet conveyance path conveys the recording sheet from the sheet feeding unit to the image forming unit. The second sheet conveyance path conveys the recording sheet from the manual sheet feeding unit to the image forming unit. The air-blowing unit blows air to an edge of the recording sheets stacked on the manual sheet feeding unit. The first and second sheet conveyance paths are merged together before the first and second sheet conveyance paths reach the image forming unit. The air-blowing unit is disposed in a space defined between the first and second sheet conveyance paths before merged and in a vicinity of the first and second sheet conveyance paths.

### BACKGROUND OF THE INVENTION

1. Field of the Invention

The invention relates to an image forming apparatus, which causes a toner to selectively adhere to a latent image formed by a difference in electrostatic potential to form a toner image; transfers the toner image on a recording sheet; and heats and pressurizes the recording sheet to thus obtain a fused image.

2. Description of the Related Art

An image forming apparatus using powdery toner can form a high-definition image and output an image closely resembling a photograph. In relation to such a high-definition image, demand for a glossy image also increases, and a high-gloss image is often requested. For these reasons, so-called coated paper whose surface is covered with a coating layer consisting of brightening agent is used. After a toner image has been transferred onto the coated paper, the toner image is sufficiently heated with a fuser, thereby forming a high-gloss toner image.

The surface of the coated paper is smooth. When a plurality of sheets of coated paper are stacked, high adhesion exists between the sheets of coated paper, which in turn poses difficulty in feeding, one by one, the coated paper from the stack of coated paper housed in a sheet tray. Therefore, as described in JP Hei. 4-23747 A and JP Hei. 5-262437, a sheet tray for housing coated paper is frequently equipped with an air blowing device. This air blowing device blows air toward an end face of the stacked sheets of coated paper laterally, to thus form an air layer between the sheets of stacked coated paper, thereby promoting separation of sheets of coated paper.

### SUMMARY OF THE INVENTION

Meanwhile, scratches are often formed on the surface of high-gloss coated paper while the paper is conveyed from the sheet tray to a position where an image is formed. Particularly, in the case of a long conveyance path or a conveyance path having many curved portions, the surface of coated paper is liable to be scratched. Especially, when a surface—on which an image is to be transferred—faces an inside of the curved portion of the conveyance path, the coated paper is brought into slide-contact with a guide of the conveyance path in the curved portion, whereby many scratches are formed in the surface. When such scratches are on the surface, the scratches sometimes become noticeable even after the toner image has been transferred on the surface, thereby deteriorating the quality of an image. For this reason, a portion of the sheet conveyance path from the sheet tray—where the coated paper is housed—to the image forming section is desirably set to a short distance while minimizing occurrence of a curve in the conveyance path.

However, on the assumption that each of a plurality of sheet trays of an image forming apparatus is equipped with an air blowing device, the space occupied by the air blowing devices becomes large, which in turn makes the apparatus bulky. Moreover, providing each sheet tray with the air blowing device makes conveyance paths from some of the sheet trays to the image forming section be longer. When this sheet tray is used, many scratches are formed on a coated paper used in this sheet tray. Therefore, the sheet tray may be unusable.

Meanwhile, when an attempt is made to place the sheet tray in proximity to a position where an image is formed in order to shorten the conveyance path, the width of the apparatus becomes larger for ensuring the space where the air blowing devices are provided for the sheet trays, thereby rendering the apparatus bulky.

In view of the circumstances, the invention has been made and provides an image forming apparatus which may be capable of smoothly feeding high-gloss coated paper, on which a high-quality image is to be formed, without rendering the apparatus bulky and without forming scratches on the surface of the coated paper.

According to one embodiment of the invention, an image forming apparatus includes a sheet feeding unit, a manual sheet feeding unit, an image forming unit, a first sheet conveyance path, a second sheet conveyance path, and an air-blowing unit. The sheet feeding unit houses recording sheets of a predetermined size and feeds the recording sheets one by one. The manual sheet feeding unit is disposed at a position where recording sheets can be placed on the manual sheet feeding unit from an outside of the image forming apparatus directly. The manual sheet feeding unit feeds the placed recording sheets one by one. The image forming unit forms an image on a recording sheet supplied from the sheet feeding unit or the manual sheet feeding unit. The first sheet conveyance path conveys the recording sheet from the sheet feeding unit to the image forming unit. The second sheet conveyance path conveys the recording sheet from the manual sheet feeding unit to the image forming unit. The air-blowing unit blows air to an edge of the recording sheets stacked on the manual sheet feeding unit. The first sheet conveyance path and the second sheet conveyance path are merged together before the first sheet conveyance path and the second sheet conveyance path reach the image forming unit. The air-blowing unit is disposed in a space defined between the first sheet conveyance path before merged and the second sheet conveyance path before merged and in a vicinity of the first and second sheet conveyance paths.

According to another embodiment of the invention, an image forming apparatus includes a sheet feeding unit, a manual sheet feeding unit, an image forming unit, a first sheet conveyance path, a second sheet conveyance path, and an air-blowing unit. The sheet feeding unit houses recording sheets of a predetermined size and feeds the recording sheets one by one. The manual sheet feeding unit is disposed at a position where recording sheets can be placed on the manual sheet feeding unit from an outside of the image forming apparatus directly. The manual sheet feeding unit feeds the placed recording sheets one by one. The image forming unit forms an image on a recording sheet supplied from the sheet feeding unit or the manual sheet feeding unit. The first sheet conveyance path conveys the recording sheet from the sheet feeding unit to the image forming unit. The second sheet conveyance path conveys the recording sheet from the manual sheet feeding unit to the image forming unit. The air-blowing unit blows air to an edge of the recording sheets stacked on the manual sheet feeding unit. The first sheet conveyance path and the second sheet conveyance path are merged together before the first sheet conveyance path and the second sheet conveyance path reach the image forming unit. The air-blowing unit is disposed in a vicinity of the first sheet conveyance path before merged and a conveyance roller provided in the first sheet conveyance path.

According to still another embodiment of the invention, an image forming apparatus includes a sheet feeding unit, a manual sheet feeding unit, an image forming unit, a first sheet conveyance path, a second sheet conveyance path, and an air-blowing unit. The sheet feeding unit houses recording sheets of a predetermined size and feeds the recording sheets one by one. The manual sheet feeding unit is disposed at a position where recording sheets can be placed on the manual sheet feeding unit from an outside of the image forming apparatus directly. The manual sheet feeding unit feeds the placed recording sheets one by one. The image forming unit forms an image on a recording sheet supplied from the sheet feeding unit or the manual sheet feeding unit. The first sheet conveyance path conveys the recording sheet from the sheet feeding unit to the image forming unit. The second sheet conveyance path conveys the recording sheet from the manual sheet feeding unit to the image forming unit. The air-blowing unit blows air to an edge of the recording sheets stacked on the manual sheet feeding unit. The first sheet conveyance path and the second sheet conveyance path are merged together before the first sheet conveyance path and the second sheet conveyance path reach the image forming unit. The recording sheet is fed from a front-side of the manual sheet feeding unit. A portion of the front-side of the manual sheet feeding unit is disposed in a vicinity of the first sheet conveyance path before merged or a conveyance roller disposed on the first sheet conveyance path.

### BRIEF DESCRIPTION OF THE DRAWINGS

Embodiment of the invention will be described in detail based on the following figures, wherein:

FIG. 1 is a schematic diagram showing an image forming apparatus according to a first embodiment of the invention;

FIG. 2A is a schematic section view of a manual sheet feeding section used in the image forming apparatus shown in FIG. 1;

FIG. 2B is a schematic plan view of the manual sheet feeding section used in the image forming apparatus shown in FIG. 1;

FIG. 3 is a schematic diagram showing an image forming apparatus according to a second embodiment of the invention;

FIG. 4A is a schematic section view of a manual sheet feeding section used in the image forming apparatus shown in FIG. 3;

FIG. 4B is a schematic plan view of the manual sheet feeding section used in the image forming apparatus shown in FIG. 3;

FIG. 4C is a schematic front view of the manual sheet feeding section used in the image forming apparatus shown in FIG. 3;

FIG. 5 is a schematic diagram showing an image forming apparatus according to a third embodiment of the invention;

FIG. 6A is a schematic section view of a manual sheet feeding section used in the image forming apparatus shown in FIG. 5;

FIG. 6B is a schematic plan view of the manual sheet feeding section used in the image forming apparatus shown in FIG. 5;

FIG. 7 is a schematic diagram showing an image forming apparatus according to a fourth embodiment of the invention;

FIG. 8 is a schematic diagram showing an image forming apparatus according to a fifth embodiment of the invention;

FIG. 9A is a schematic section view of a manual sheet feeding section used in the image forming apparatus shown in FIG. 8;

FIG. 9B is a schematic plan view of the manual sheet feeding section used in the image forming apparatus shown in FIG. 8;

FIG. 10 is a schematic diagram showing an image forming apparatus according to a sixth embodiment of the invention;

FIG. 11A is a schematic section view of a manual sheet feeding section used in the image forming apparatus shown in FIG. 9;

FIG. 11B is a schematic plan view of the manual sheet feeding section used in the image forming apparatus shown in FIG. 9;

FIG. 12 is a schematic diagram showing an image forming apparatus according to a seventh embodiment of the invention;

FIG. 13 is a schematic diagram showing an image forming apparatus according to an eighth embodiment of the invention; and

FIG. 14 is a schematic diagram showing an image forming apparatus according to a ninth embodiment of the invention.

### DETAILED DESCRIPTION OF THE EMBODIMENTS

Embodiments of the invention will be described hereunder by reference to the drawings.

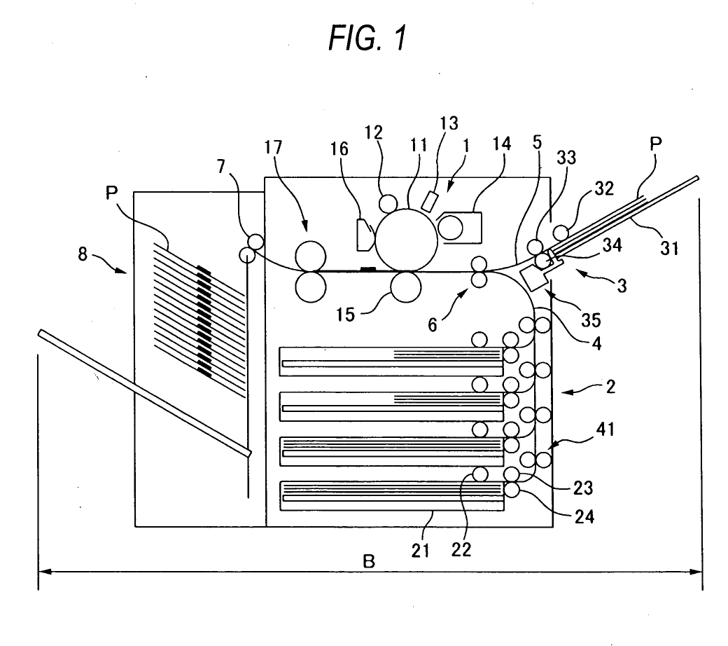

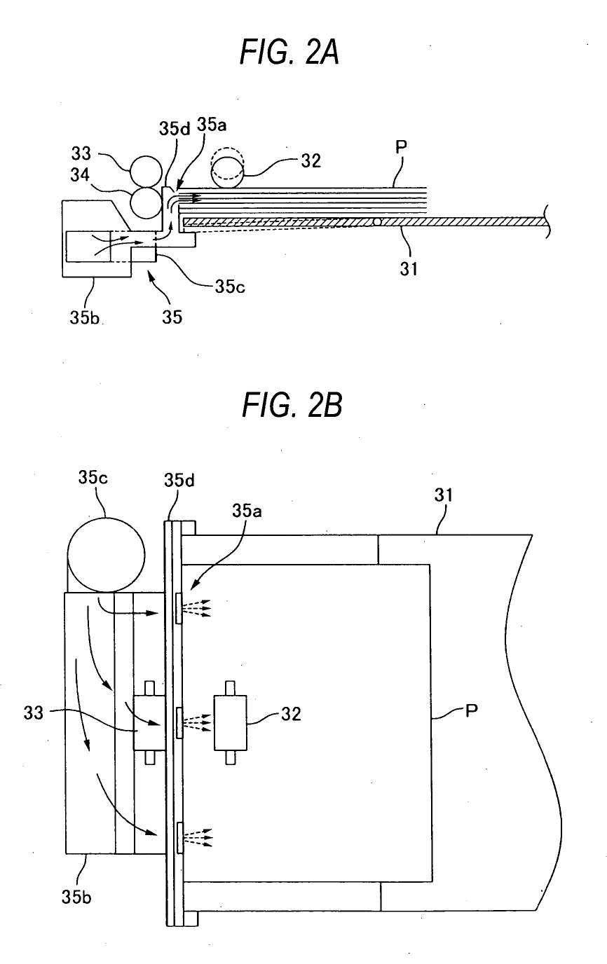

FIG. 1 is a schematic diagram showing an image forming apparatus according to a first embodiment of the invention. FIGS. 2A and 2B are schematic diagrams of a manual sheet feeding section used in the image forming apparatus.

The image forming apparatus has an image forming section 1 for forming an image on the basis of a digital image signal by means of electrophotography. A sheet feeding section 2 for feeding housed recording sheets to the image forming section 1 is provided below the image forming section 1. A manual sheet feeding section 3—on which recording sheets can be placed from an outside of the image forming apparatus directly—is provided in a side portion of the image forming apparatus. A first sheet conveyance path 4 and a second sheet conveyance path 5 are provided. The first sheet conveyance path 4 feeds a recording sheet from the sheet feeding section 2 to the image forming section 1. The second sheet conveyance path 5 feeds the recording sheet from the manual sheet feeding section 3 to the image forming section 1. These conveyance paths 4 and 5 merge into each other at a position on upstream of a registration roller 6, and subsequently feed the recording sheet to the image forming section 1.

The image forming section 1 has a cylindrical photosensitive drum 11, a charger 12, an exposure device 13, a development device 14, a transfer device 15 and a cleaning device 16. The charger 12, exposure device 13, development device 14, transfer device 15 and cleaning device 16 are provided around the photosensitive drum 11. When the photosensitive drum 11 is exposed to image light after having been uniformly charged, a latent image stemming from a difference between electrostatic potentials is formed on the surface of the photosensitive drum 11. The charger 12 uniformly charges the surface of the photosensitive drum 11. The exposure device 13 radiates image light onto the photosensitive drum 11 to thus form the latent image on the surface of the photosensitive drum 11. The development device 14 selectively transfers toner on the latent image onto the photosensitive drum 11, to thus form a toner image. The transfer device 15 transfers the toner image formed on the photosensitive drum 11 onto a recording sheet. The cleaning device 16 removes the toner still remaining on the photosensitive drum 11 after transfer of the toner image.

A fuser 17, which heats the toner image on the recording sheet and presses the toner image onto the recording sheet, is provided on downstream of the transfer device 15. A paper discharge roller 7 for feeding the recording sheet from a housing is provided on downstream of the fuser 17. This paper discharge roller 7 discharges the recording sheet to a paper discharge tray 8.

A photosensitive drum, which can be used for the photosensitive drum 11, includes a photosensitive material layer formed on the surface of a metal drum, wherein the photosensitive material layer includes various inorganic photosensitive materials, an organic photosensitive material, an amorphous selenium-based photosensitive material, and an amorphous silicon-based photosensitive material, such as Se, a-Si, and CdS.

The charger 12 is formed by coating a metal roller having conductivity, such as stainless steel or aluminum, with a high-resistance material. The charger 12 abuts against the photosensitive drum 11, and is rotated so as to follow the photosensitive drum 11. As a result of application of a predetermined voltage to the charger 12, electric discharge continually develops in a minute gap in the vicinity of a contact portion between the roller of the charger 12 and the photosensitive drum 11, thereby essentially-uniformly charging the surface of the photosensitive drum 11.

The exposure device 13 includes arranged LEDs, which blink for each pixel in accordance with an image signal. The exposure device 13 blinks in accordance with circular movement of a circumferential surface of the photosensitive drum 11, thereby exposing the circumferential surface of the photosensitive drum 11 in accordance with the image signal. Thereby, the potential of an exposed area on the circumferential surface of the photosensitive drum 11 is attenuated, so that the latent image stemming from a difference in electrostatic potential is formed.

The developer 14 transfers toner to the latent image within an electric field generated at a position, which is in close proximity to and faces the photosensitive drum 11, thereby forming a visible image.

The fuser 15 includes a heat roller having a built-in heat source, and a pressure roller to be brought into pressure-contact with the heat roller. The heat roller and the pressure roller are arranged parallel to each other, thereby forming a nip portion where the rollers are brought into pressure-contact with each other. The recording sheet—on which the toner image has been transferred—is fed to the nip portion, and is heated and pressurized between the heat roller and the pressure roller, both of which are rotationally driven. As a result, softened toner is pressure-fixed on to the recording sheet.

The sheet feeding section 2 disposed below the image forming section 1 includes a sheet tray 21, a pickup roller 22, a paper feed roller 23, a facing roller 24. The sheet tray 21 houses, in a stacked manner, recording sheets cut to a predetermined size. The pickup roller 22 takes, one by one from the top, the recording sheets housed in the sheet tray 21. The paper feed roller 23 feeds a recording sheet taken by the pickup roller to the first sheet conveyance path 4. The facing roller 24 faces the paper feed roller 23 with the recording sheet interposed therebetween, to thus prevent overlapping conveyance of recording sheets. Four sheet trays including one having the above structure are arranged in a vertical direction, thereby feeding the recording sheet of selected size toward the image forming section 1.

The first conveyance path 4 includes conveyance rollers 41 for conveying a recording sheet fed from one of the plurality of sheet trays 21 provided in the sheet feeding section 2. The first conveyance path 4 includes guide members (not shown) on both sides of a path over which the recording sheet is conveyed. The conveyance rollers 41 are provided in parallel with the guide member. The conveyance rollers 41 face each other. A recording sheet is nipped between these conveyance rollers 41, and one of the conveyance rollers 41 is rotationally driven to thus convey the recording sheet in a predetermined direction.

The manual sheet feeding section 3 provided in the side portion of the housing of the image forming apparatus includes a manual feed tray 31, a pickup roller 32, a paper feed roller 33, a facing roller 34, and an air-blower 35. The manual feed tray 31 overhang in an obliquely upward direction. The pickup roller 32 withdraws one by one the recording sheets stacked on the manual feed tray. The paper feed roller 33 feeds a thus-withdrawn recording sheet to the second conveyance path 5. The facing roller 34 prevents the recording sheets from being conveyed in an overlap manner. The air blowing device 35 blows air to the front edge of the recording sheets stacked in the manual feed tray 31. The manual feed tray 31 is opened toward outside of the housing of the image forming apparatus. Recording sheets are inserted from the outside of the housing to replenish the recording sheets. The pickup roller 32, the paper feed roller 33, and the facing roller 34 have the same functions as those of counterparts employed in the sheet feeding section 2 provided within the housing of the image forming apparatus.

As shown in FIG. 2, the air blowing device 35 provided in the manual sheet feed section 3 includes a blow-off port 35a, a duct 35 and a blower 35c. The blow-off port 35a is provided in the front side of the air blowing device 35 in a direction in which the recording sheets P are fed. The duct 35b communicates with the blow-off port 35c. The blower 35c supplies air flow to the duct 35b. The air blown into the duct 35b by the blower 35c is blown from the blow-off port 35a to the front edges of the recording sheets in essentially parallel to the plane of a recording sheets P. As a result, the air flow is formed between the recording sheets, thereby rendering separation of the recording sheets easy. Thus, the recording sheets are smoothly fed to the image forming section 1 one by one.

The duct 35b is disposed at a position anterior to the paper feed roller 33 and the facing roller 34, which are provided on a front wall of the manual feed tray 31. As shown in FIG. 1, the duct 35b is provided in a vicinity of the first conveyance path 4 and the second conveyance path 5. The blower 35c is connected to one end of the duct 35b, and air is blown from the blower 35c into the duct 35b. The duct 35b is in communication with the blow-off port 35a formed in a front wall 35d of the manual feed tray 31 by way of a position below the facing roller 34, and can blow the air flow toward the edge of the stacked recording sheets.

The above-described image forming apparatus operates in the following manner.

A recording sheet serving as a medium for an image is selected on the basis of a signal input by an operator or image information input from another device. When PPC paper housed in the sheet feeding section 2 is selected as a recording medium, the recording sheet is withdrawn from the sheet tray 21 and conveyed toward the image forming section 1 over the first conveyance path 4 by means of the conveyance roller 41. At this time, the conveyance path becomes slightly longer. Particularly, when a recording sheet is fed from the lowermost sheet tray, the conveyance path becomes longer. However, an image to be formed on the PPC paper has low gloss. Therefore, scratches on the surface of the recording sheet hardly arise problems.

In the image forming section 1, a toner image is formed on the photosensitive drum 11. This toner image is transferred onto the synchronously-fed PPC paper at a portion facing the transfer device 15. The PPC paper is heated and pressurized by passing through the fuser 17, where upon the transferred image becomes a fused image. Subsequently, the PPC paper on which the toner image is fused is discharged to the outside of the device by means of the paper discharge roller 7, and is housed in the paper discharge tray 8.

When an attempt is made to form a high-gloss image, feeding paper from the manual sheet feeding section 3 is selected. Coated paper are withdrawn from the manual feed tray 31 one sheet one by one, and the thus-withdrawn coated paper is fed to the image forming section 1 by way of the second conveyance path 5. Like a case where a toner image is formed on the PPC paper, the toner image is formed on the coated paper, and the toner image is sufficiently heated and fused by the fuser 17. As a result, a high-gloss image is obtained. The conveyance path for the coated paper serving as the recording sheet is short. Although the conveyance path includes curves along which a surface of the coated paper—on which the toner image is to be transferred—is oriented inside, the curvature radii of the curves are small. As a result, the surface of the coated paper is prevented from being scratched. Hence, a superior image is obtained.

On the other hand, the duct 35b of the air blowing device 35 provided in the manual sheet feed section 3 is interposed between the first conveyance path 4 and the second conveyance path 5. A tip end of the manual feed tray 31 protrudes into the housing of the image forming apparatus for the purpose of effectively utilizing space. Consequently, the overall width of the apparatus (denoted by B in FIG. 1) can be made small.

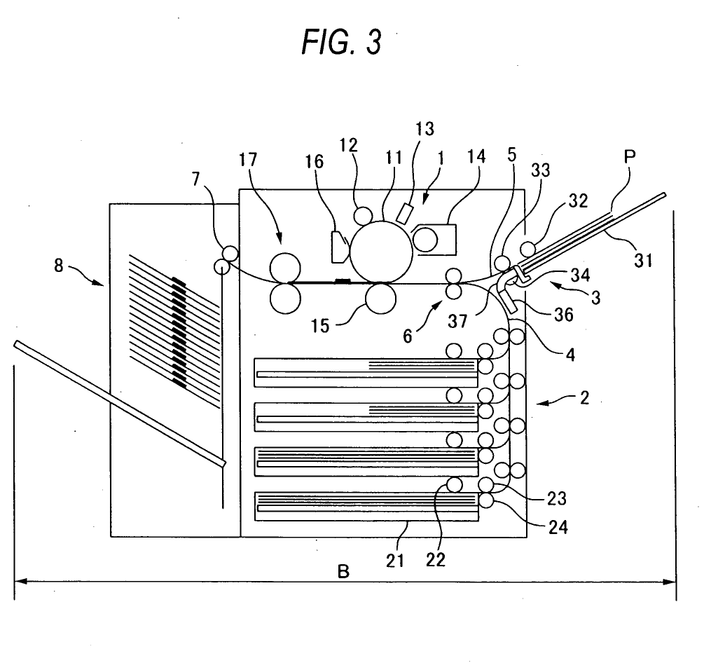

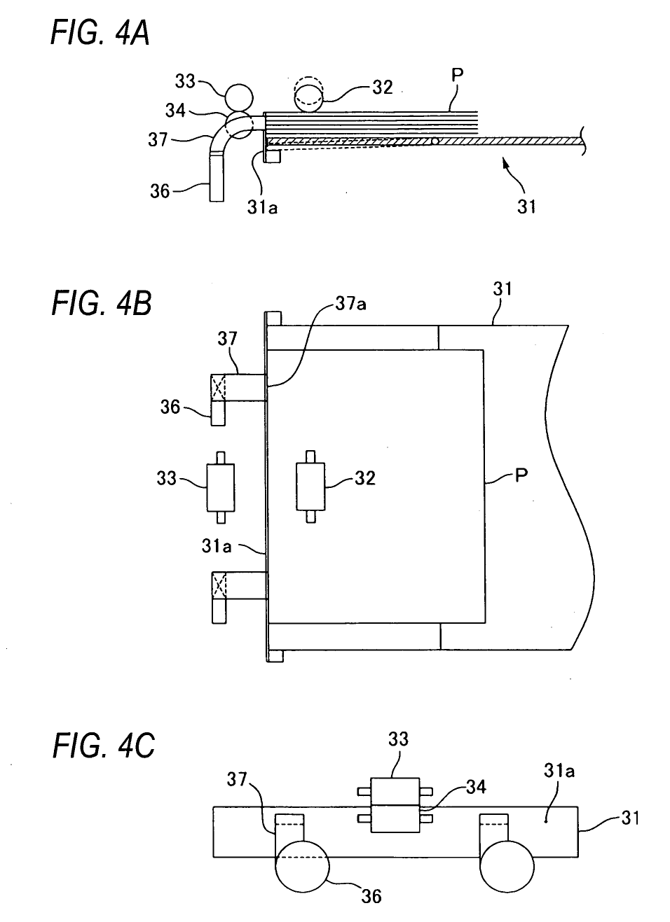

FIG. 3 is a schematic diagram showing an image forming apparatus according to a second embodiment of the invention. FIGS. 4A to 4C are schematic diagrams of a manual sheet feeding section used in the image forming apparatus.

In this image forming apparatus, the air blowing device 35 provided in the manual sheet feeding section 3 includes a plurality of blowers 36 and short ducts 37. The blowers 36 are provided anterior to the manual feed tray 31. The short ducts 37 guide the air flow from the blowers 36 to blow-off ports 37a formed in the front wall body 31a of the manual feed tray 31. The blowers 36 are disposed in close proximity to the first conveyance path 4 for conveying the recording sheet from the sheet feed section 2. Each duct 37 is bent to an essentially right angle from the blower 36 to the blow-off port 37a. Each duct 37 comes into close proximity to the second conveyance path 5 for the manual feed tray 31.

In this image forming apparatus, when coated paper stored in the manual feed tray 31 has been selected as a recording sheet on which an image is to be formed, the air flow is blown from the blowers 36 toward the edge of the coated paper from forward of the manual feed tray 31 by way of the ducts 37. As a result, the sheets of coated paper are taken one by one, and a superior high-gloss image is formed on the coated paper in the image forming section 1. Moreover, the blowers 36 are arranged to come into close proximity with the first and second conveyance paths 4, 5 before the position where the first and second conveyance paths 4, 5 are merged with each other, thereby effectively utilizing space and preventing increase of the apparatus size.

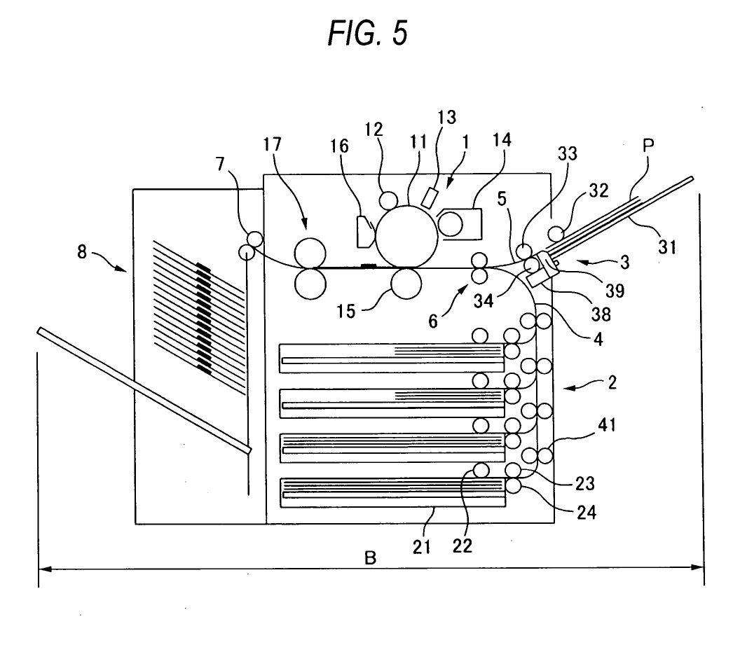

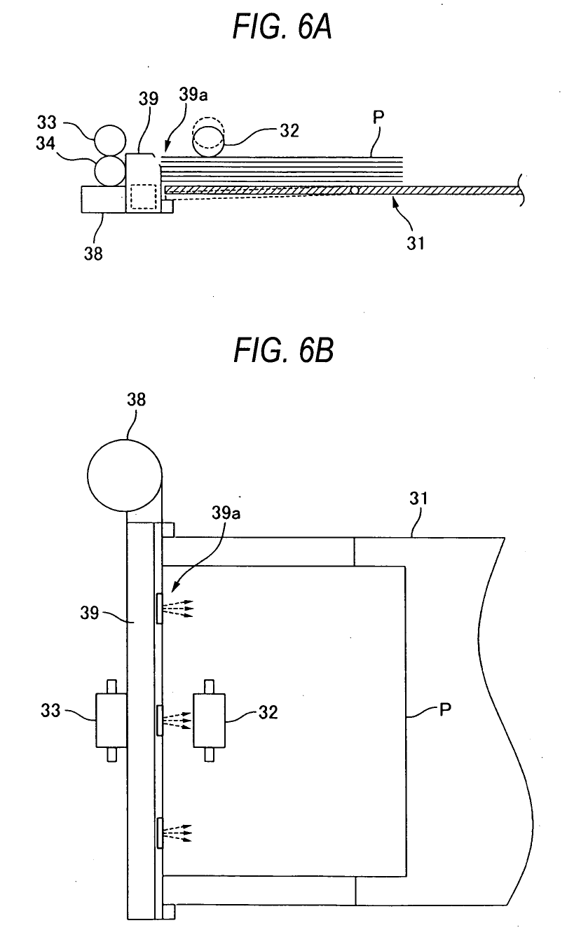

FIG. 5 is a schematic diagram showing an image forming apparatus according to a third embodiment of the invention. FIGS. 6A and 6B are schematic diagrams of a manual sheet feed section used in the image forming apparatus.

In this image forming apparatus, a wall body 39 disposed anterior to the manual feed tray 31 provided in the manual sheet feeding section 3 is hollow, and the hollow area is used as a duct for the air blowing device. Specifically, blow-off ports 39a are provided in an interior side of the wall body 39 facing the manual feed tray 31. A blower 38 is disposed beside the manual feed tray 31, thereby supplying the air flow into the hollow portion of the wall body 39 acting as a duct. As shown in FIG. 5, the blower 38 is disposed so as to come into close proximity with the first conveyance path 4 over which the recording sheet is conveyed from the sheet feed section 2 to the image forming section 1.

In other respects, this image forming apparatus is identical in configuration with that shown in FIG. 1.

Even such an image forming apparatus can house coated paper in the manual sheet feeding section 3, and can form a high-gloss image by appropriately conveying the coated paper one by one without forming scratches on the surface of the coated paper. Moreover, the entire width B of the apparatus can be reduced by effectively utilizing the space existing between the first conveyance path 4 and the second conveyance path 5.

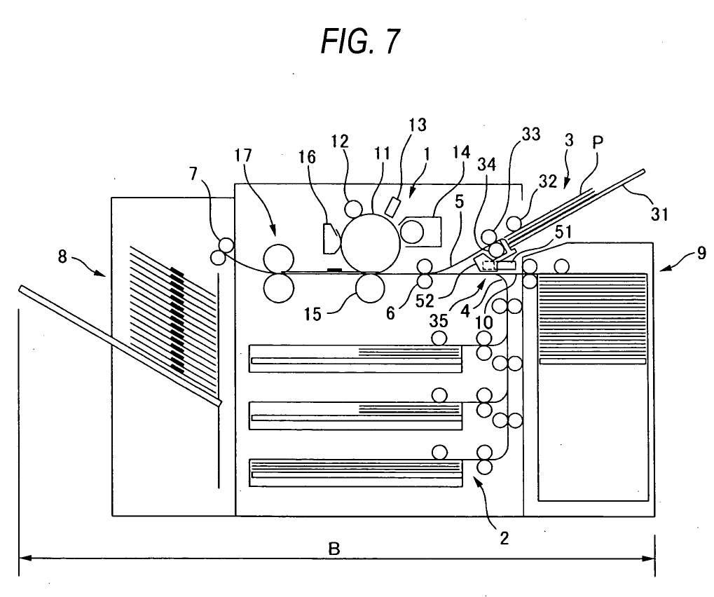

FIG. 7 is a schematic diagram showing an image forming apparatus according to a fourth embodiment of the invention.

A second sheet feeding section 9 having a large-quantity recording sheet storage section is provided on the side portion of the main body of this image forming apparatus. A third sheet conveyance path 10 for feeding a recording sheet from the second sheet feeding section 9 is merged into the first conveyance path 4 for conveying a recording sheet from the first sheet feeding section 2 provided with in the housing. The manual sheet feeding section 3 is disposed above the second sheet feeding section 9, and the second sheet conveyance path 5 for conveying a recording sheet from the manual sheet feeding section 3 is merged into a portion of the first conveyance path 4 subsequent to a position where the first conveyance path 4 are merges with the third sheet conveyance path 10.

As with the image forming apparatus shown in FIG. 1, the manual sheet feeding section 3 includes the manual feed tray 31, the pickup roller 32, the paper feed roller 33, the facing roller 34, and the air blowing device 35. The air blowing device 35 provided in the manual sheet feeding section 3 includes an air blow-off port (not shown), a duct 52 communicating with the blow-off port, and a blower 51 for supplying an air flow to the duct 52.

The duct 52 is slightly different from the counterpart of the apparatus shown in FIG. 1 in terms of a sectional profile. However, the duct 52 is disposed in close proximity to the first and second conveyance paths 4, 5, and air is supplied from the blower 51. The blower 51 is disposed along and in close proximity to the first and third sheet conveyance paths 4, 10.

In other respects, this image forming apparatus is identical in configuration with that shown in FIG. 1.

In such an image forming apparatus, the manual sheet feeding section 3 enters an upper portion of the first conveyance path 4 of the main body of the image forming apparatus, and the second sheet conveyance path 5 from the manual sheet feeding section 3 becomes shorter. Consequently, the coated paper can be housed in the manual feed tray 31, and a high-gloss image can be formed by appropriately conveying the coated paper one by one without forming scratches on the surface of the coated paper. Moreover, the overall width B of the apparatus can be reduced by effectively utilizing the space existing between the first conveyance path 4 and the second conveyance path 5.

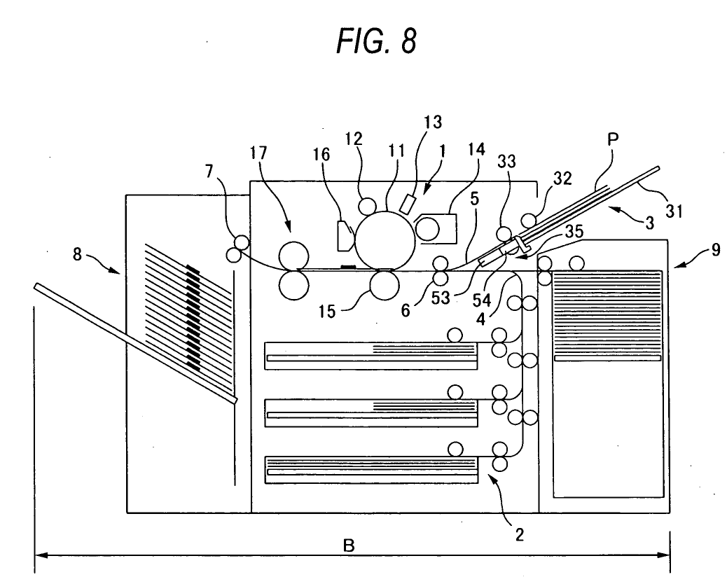

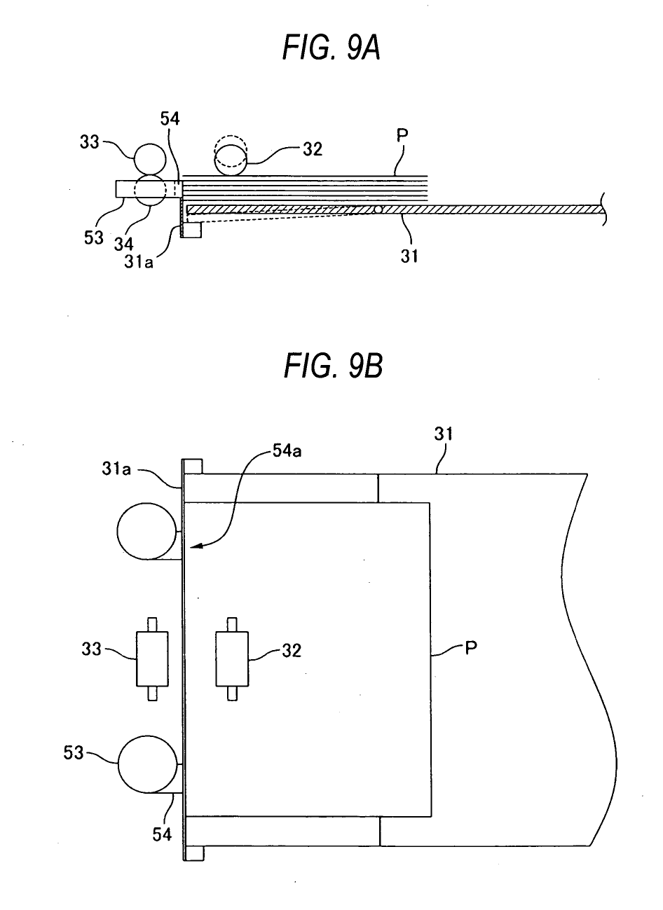

FIG. 8 is a schematic diagram showing an image forming apparatus according to a fifth embodiment of the invention. FIGS. 9A and 9B are schematic diagrams of a manual sheet feeding section 31 used in this image forming apparatus.

As with the image forming apparatus shown in FIG. 3, the air blowing device 35 provided in the manual sheet feeding section 3 includes a plurality of blowers 53 disposed anterior to the manual feed tray 31, and short ducts 54 for guiding an air flow from the blowers 53 to blow-off ports 54a formed in the forward wall body 31a of the manual feed tray 31. The blowers 53 are disposed anterior to the manual feed tray 31 as well as in close proximity to and along the second sheet conveyance path 5 for conveying the recording sheets P from the manual feed tray 31. Air is blown from the blowers 53 to the recording sheets P, from the front thereof, stacked in the manual feed tray 31.

In other respects, this image forming apparatus is identical in configuration with that shown in FIG. 7.

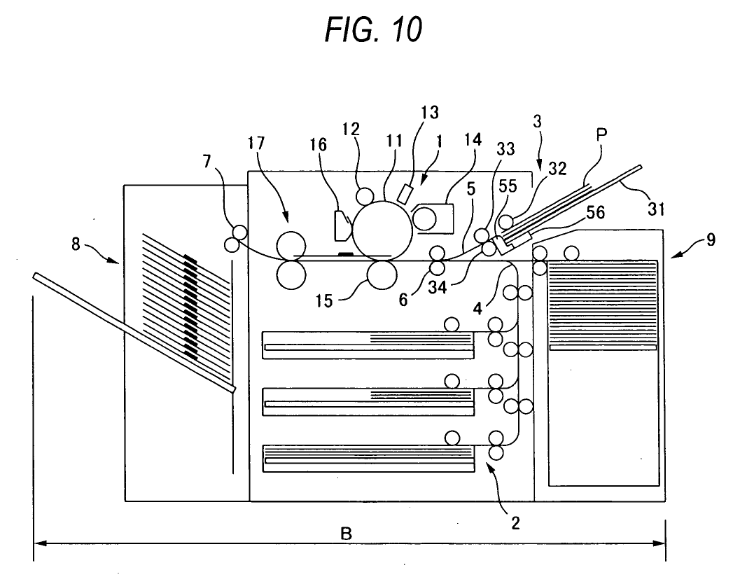

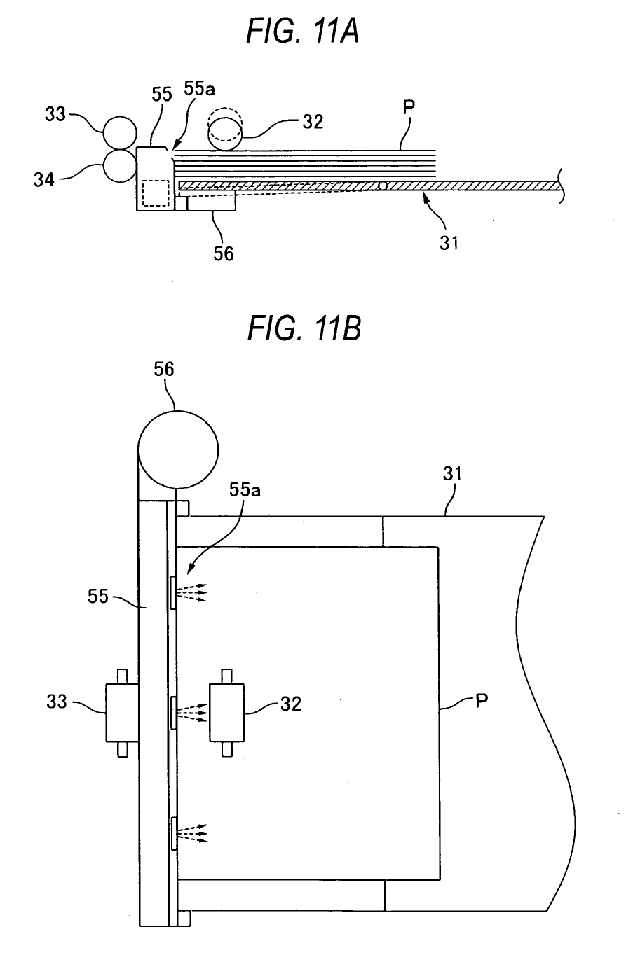

FIG. 10 is a schematic diagram showing an image forming apparatus according to a sixth embodiment of the invention. FIGS. 11A and 11B are schematic diagrams of a manual sheet feeding section 31 used in the image forming apparatus.

As with the apparatus shown in FIGS. 5, 6A, and 6B, a front-side wall body 55 of the manual feed tray 31 provided in the manual sheet feeding section 3 is hollow, and this hollow portion serves as a duct for blowing an air flow from blow-off ports 55a to the front edge of the recording sheets P. A blower 56 disposed beside the manual feed tray 31 is provided rearward in relation to the front-side wall body 55 of the manual feed tray 31, and the hollow front-side wall body 55 is arranged in close proximity to the first sheet conveyance path 4.

In other respects, this image forming apparatus is identical in configuration with that shown in FIG. 7.

Even in the case of such an image forming apparatus, the overall width B of the apparatus can be reduced by arranging the air blowing device through effective utilization of the space existing between the first conveyance path 4 and the second conveyance path 5.

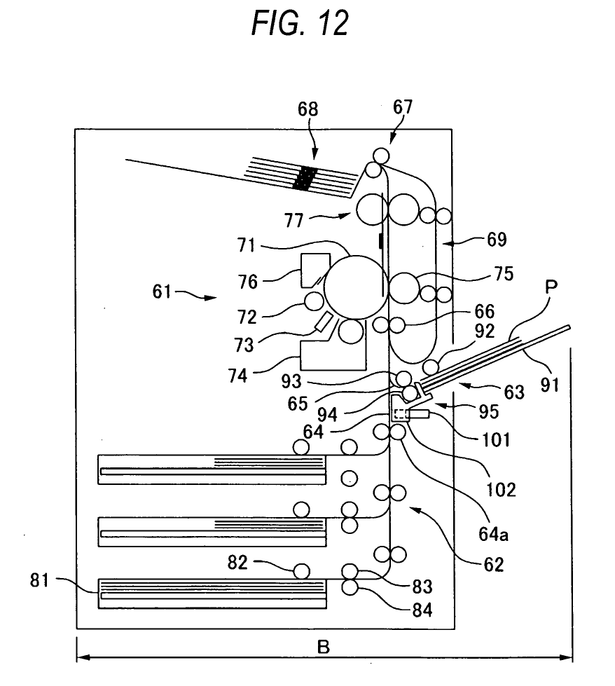

FIG. 12 is a schematic diagram showing an image forming apparatus according to a seventh embodiment of the invention.

In this image forming apparatus, a sheet feeding section 62 is provided below an image forming section 61. A recording sheet is conveyed upward from the sheet feeding section 62 along the side surface of the housing of the image forming apparatus main body. The image forming section 61 transfers a toner image onto the recording sheet while being conveyed upward from below. The recording sheet on which the toner image has been transferred is fed to a fuser 77 disposed at a higher position. The recording sheet having passed through the fuser 77 is discharged to a paper discharge tray 68 disposed above the housing by way of the paper discharge roller 67. In contrast, a manual sheet feeding section 63 is disposed on a side portion of the housing. A second sheet conveyance path 65 through which a recording sheet is fed from the manual sheet feeding section 63 is merged into the first sheet conveyance path 64 for conveying a recording sheet from the sheet feeding section 62 to the image forming section 61.

As with the image forming apparatus shown in FIG. 1, the image forming section 61 includes a photosensitive drum 71, a charger 72, an exposure device 73, a development device 74, and a transfer device 75. The sheet feeding section 62 includes a sheet tray 81, a pickup roller 82, a paper feed roller 83, and a facing roller 84. As with the sheet feeding section 62, the manual sheet feeding section 63 includes a manual feed tray 91, a pickup roller 92, a paper feed roller 93, a facing roller 94, and an air blowing device 95. As with the air blowing device 35 shown in FIG. 2, the air blowing device 95 includes a blow-off port (not shown) provided in the front wall body of the manual tray 91, ducts 102, and a blower 101. The ducts 102 are provided anterior to the paper feed roller 93, and an air flow extending from the ducts 102 to the blow-off port is formed. A front portion of the manual feed tray 91 is provided so as to enter the housing. The ducts 102 are provided in close proximity to the first sheet conveyance path 64 for conveying a recording sheet from the sheet feeding section 62 to the image forming section 61 and the conveyance roller 64a for conveying the recording sheet on the sheet conveyance path.

Reference numeral 69 in FIG. 12 denotes a double-sided transfer conveyance path for, once again, conveying the recording sheet, on one surface of which an image has been transferred and fused, toward upstream of the image forming section 61 in order to transfer a different toner image onto the back of the recording sheet.

As with the image forming apparatus shown in FIG. 1, even when such an image forming apparatus forms a high-gloss image, the coated paper set on the manual feed tray 91 is conveyed to the image forming section 61, where a toner image is transferred onto the coated paper and then fused. At this time, the manual sheet feeding section 63 is disposed at a position higher than the sheet tray 81 of the sheet feed section 62. Therefore, the conveyance path is shortened. Consequently, scratches are unlikely to be formed on the surface of the coated paper. The second sheet conveyance path 65 from the manual feed tray 91 to the image forming section 61 has a curved section having a large radius of curvature. In this image forming apparatus, a toner image is transferred onto the surface of the recording sheet facing downward within the manual feed tray 91. This surface is made to face outside of the curved section and brought into lighter slide-contact with the guide member, so that a superior image is formed without formation of many scratches on the surface thereof.

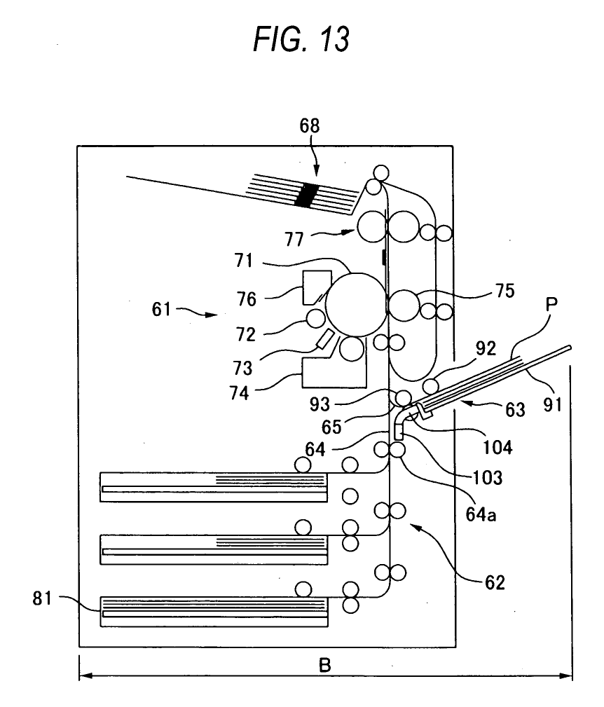

In place of the manuals sheet feeding section shown in FIG. 12, a manual sheet feeding section shown in FIG. 13 may be used in the image forming apparatus. As with the apparatus shown in FIG. 4, the air blowing device of the manual sheet feeding section is configured such that a plurality of blowers 103 are disposed anterior to the manual feed tray 91, and that air is blown from the blowers 103 into the manual feed tray 91 by way of the duct 104. The blowers 103 are disposed in close proximity to the first sheet conveyance path 64 and the conveyance roller 64a provided in this sheet conveyance path.

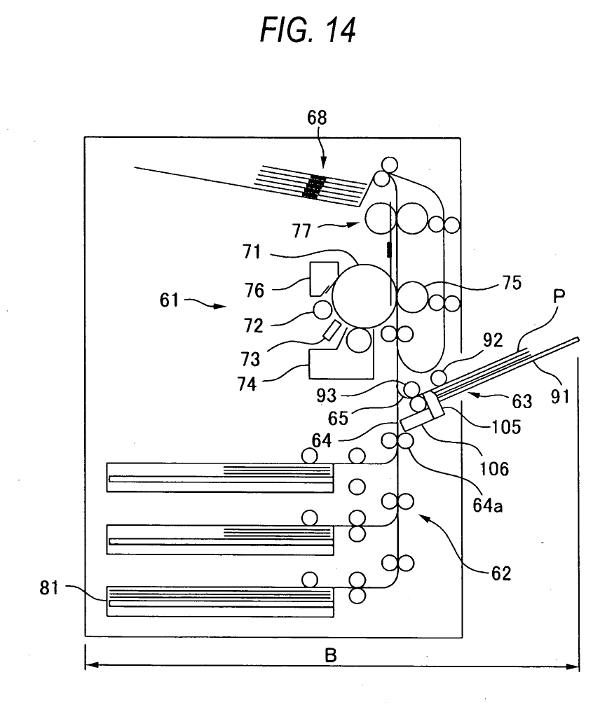

As shown in FIG. 14, the air blowing device may be formed so that the forward wall body 105 of the manual feed tray 91 is hollow, and use the hollow forward wall body 105 as a duct. The air blowing device has the same configuration as that of the apparatus shown in FIG. 6, and the blower 106 is disposed so as to come into close proximity to the first sheet conveyance path 64 and the conveyance roller 64a.

According to one embodiment of the invention, the air-blowing unit blows air to an edge of the recording sheets stacked on the manual sheet feeding unit. When using a coated paper, the manual sheet feeding unit is mainly used. Therefore, it is not necessary to consider that the sheet feeding unit handles a coated paper, and an air-blowing unit for the sheet feeding unit is not required. As a result, increase of the apparatus size can be avoided. A space defined between the first sheet conveyance path before merged and the second sheet conveyance path before merged is partitioned by a conveyance path having a width equal to or greater than the width of the recording sheet. Thus, it is difficult to utilize this space. However, as a result of providing the air-blowing unit in this space, the internal space of the apparatus can be effectively utilized, and increase of the apparatus size can be prevented. Particularly, when the conveyance path is curved with a large curvature radius so that the recording sheet is hardly scratched, a large space is formed between the first sheet conveyance path and the second sheet conveyance path. Therefore, this space can be effectively utilized. Consequently, the manual sheet feeding unit with the air-blowing unit may be disposed in a vicinity of a position where an image is transferred. In this case, the width of the apparatus can be made small.

The air-blowing unit may include members required for directing a flow of air to the stacked recording sheets, such as a duct and/or a blower. Even if a member constituting the air-blowing unit is integrally assembled with a member, such as a tray, constituting the manual sheet feeding unit, an unutilized space may be made small by means of arranging those units in the vicinity the second conveyance path, thereby effectively preventing increase of the apparatus size.

As has been described above, in the image forming apparatus, the air-blowing unit blows air to the recording sheets stacked on the manual sheet feeding unit. Therefore, a coated paper used as the recording sheet can be supplied from the manual sheet feeding unit to the image forming unit smoothly. Also, the air-blowing unit can be arranged with effectively utilizing the internal space of the apparatus, thereby preventing the apparatus from becoming bulky. Moreover, the conveyance path for a recording sheet from the manual sheet feeding unit to the image forming unit is made short, thereby protecting the surface of high-gloss coated paper from being scratched.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
a sheet feeding unit that houses recording sheets of a predetermined size and feeds the recording sheets one by one;
a manual sheet feeding unit disposed at a position where recording sheets can be placed on the manual sheet feeding unit from an outside of the image forming apparatus directly, the manual sheet feeding unit feeding the placed recording sheets one by one;
wherein the manual sheet feeding unit comprises a tray on which the recording sheets are stacked, the tray protruding from a main body of the image forming apparatus toward an outside of the main body;
an image forming unit that forms an image on a recording sheet supplied from the sheet feeding unit or the manual sheet feeding unit;
a first sheet conveyance path that conveys the recording sheet from the sheet feeding unit to the image forming unit;
a second sheet conveyance path that conveys the recording sheet from the manual sheet feeding unit to the image forming unit; and
an air-blowing unit that blows air to an edge of the recording sheets stacked on the manual sheet feeding unit, wherein:
the first sheet conveyance path and the second sheet conveyance path are merged together before the first sheet conveyance path and the second sheet conveyance path reach the image forming unit, and
the air-blowing unit is disposed in a space defined between the first sheet conveyance path before merged and the second sheet conveyance path before merged and in a vicinity of the first and second sheet conveyance paths.

2. The image forming apparatus according to claim 1, wherein the second sheet conveyance path is shorter in a conveyance distance of the recording sheet than the first sheet conveyance path.

3. The image forming apparatus according to claim 1, wherein:
the sheet feeding unit is disposed below the image forming unit,
the first sheet conveyance path conveys the recording sheet upward along one side surface of the main body of the image forming apparatus, and then changes a conveyance direction of the recording sheet to a side surface opposite to the one side surface,
the image forming unit forms the image on an upper surface of the recording sheet being conveyed in a lateral direction,
the second sheet conveyance path is merged from above into a portion of the first sheet conveyance path where the first sheet conveyance path conveys the recording sheet in the lateral direction, and
the second sheet conveyance path comprises a path from the manual sheet feeding unit to the image forming unit, which is a straight line or has a larger curvature radium than a maximum curvature radium of the first sheet conveyance path.

4. The image forming apparatus according to claim 2, wherein:
the sheet feeding unit is disposed below the image forming unit,
the first sheet conveyance path conveys the recording sheet upward along one side surface of the main body of the image forming apparatus, and then changes a conveyance direction of the recording sheet to a side surface opposite to the one side surface,
the image forming unit forms the image on an upper surface of the recording sheet being conveyed in a lateral direction,
the second sheet conveyance path is merged from above into a portion of the first sheet conveyance path where the first sheet conveyance path conveys the recording sheet in the lateral direction, and
the second sheet conveyance path comprises a path from the manual sheet feeding unit to the image forming unit, which is a straight line or has a larger curvature radium than a maximum curvature radium of the first sheet conveyance path.

5. The image forming apparatus according to claim 1, wherein the air-blowing unit blows air to the front edge of the recording sheets stacking in the manual sheet feeding unit.

6. An image forming apparatus comprising:
a sheet feeding unit that houses recording sheets of a predetermined size and feeds the recording sheets one by one;
a manual sheet feeding unit disposed at a position where recording sheets can be placed on the manual sheet feeding unit from an outside of the image forming apparatus directly, the manual sheet feeding unit feeding the placed recording sheets one by one;
wherein the manual sheet feeding unit comprises a tray on which the recording sheets are stacked, the tray protruding from a main body of the image forming apparatus toward an outside of the main body;
an image forming unit that forms an image on a recording sheet supplied from the sheet feeding unit or the manual sheet feeding unit;
a first sheet conveyance path that conveys the recording sheet from the sheet feeding unit to the image forming unit;
a second sheet conveyance path that conveys the recording sheet from the manual sheet feeding unit to the image forming unit; and
an air-blowing unit that blows air to an edge of the recording sheets stacked on the manual sheet feeding unit, wherein:
the first sheet conveyance path and the second sheet conveyance path are merged together before the first sheet conveyance path and the second sheet conveyance path reach the image forming unit, and
the air-blowing unit is disposed in a vicinity of the first sheet conveyance path before merged and a conveyance roller provided in the first sheet conveyance path.

7. The image forming apparatus according to claim 6, wherein the second sheet conveyance path is shorter in a conveyance distance of the recording sheet than the first sheet conveyance path.

8. The image forming apparatus according to claim 6, wherein:
the sheet feeding unit is disposed below the image forming unit,
the first sheet conveyance path conveys the recording sheet upward along one side surface of the main body of the image forming apparatus, and then changes a conveyance direction of the recording sheet to a side surface opposite to the one side surface,
the image forming unit forms the image on an upper surface of the recording sheet being conveyed in a lateral direction,
the second sheet conveyance path is merged from above into a portion of the first sheet conveyance path where the first sheet conveyance path conveys the recording sheet in the lateral direction, and
the second sheet conveyance path comprises a path from the manual sheet feeding unit to the image forming unit, which is a straight line or has a larger curvature radium than a maximum curvature radium of the first sheet conveyance path.

9. The image forming apparatus according to claim 7, wherein:
the sheet feeding unit is disposed below the image forming unit,
the first sheet conveyance path conveys the recording sheet upward along one side surface of the main body of the image forming apparatus, and then changes a conveyance direction of the recording sheet to a side surface opposite to the one side surface,
the image forming unit forms the image on an upper surface of the recording sheet being conveyed in a lateral direction,
the second sheet conveyance path is merged from above into a portion of the first sheet conveyance path where the first sheet conveyance path conveys the recording sheet in the lateral direction, and
the second sheet conveyance path comprises a path from the manual sheet feeding unit to the image forming unit, which is a straight line or has a larger curvature radium than a maximum curvature radium of the first sheet conveyance path.

10. The image forming apparatus according to claim 6, wherein the air-blowing unit blows air to the front edge of the recording sheets stacking in the manual sheet feeding unit.

11. An image forming apparatus comprising:
a sheet feeding unit that houses recording sheets of a predetermined size and feeds the recording sheets one by one;
a manual sheet feeding unit disposed at a position where recording sheets can be placed on the manual sheet feeding unit from an outside of the image forming apparatus directly, the manual sheet feeding unit feeding the placed recording sheets one by one;
wherein the manual sheet feeding unit comprises a tray on which the recording sheets are stacked, the tray protruding from a main body of the image forming apparatus toward an outside of the main body;
an image forming unit that forms an image on a recording sheet supplied from the sheet feeding unit or the manual sheet feeding unit;
a first sheet conveyance path that conveys the recording sheet from the sheet feeding unit to the image forming unit;
a second sheet conveyance path that conveys the recording sheet from the manual sheet feeding unit to the image forming unit; and
an air-blowing unit that blows air to an edge of the recording sheets stacked on the manual sheet feeding unit, wherein:
the first sheet conveyance path and the second sheet conveyance path are merged together before the first sheet conveyance path and the second sheet conveyance path reach the image forming unit,
the recording sheet is fed from a front-side of the manual sheet feeding unit, and
a portion of the front-side of the manual sheet feeding unit is disposed in a vicinity of the first sheet conveyance path before merged or a conveyance roller disposed on the first sheet conveyance path.

12. The image forming apparatus according to claim 11, wherein the second sheet conveyance path is shorter in a conveyance distance of the recording sheet than the first sheet conveyance path.

13. The image forming apparatus according to claim 11, wherein:
the sheet feeding unit is disposed below the image forming unit,
the first sheet conveyance path conveys the recording sheet upward along one side surface of the main body of the image forming apparatus, and then changes a conveyance direction of the recording sheet to a side surface opposite to the one side surface,
the image forming unit forms the image on an upper surface of the recording sheet being conveyed in a lateral direction,
the second sheet conveyance path is merged from above into a portion of the first sheet conveyance path where the first sheet conveyance path conveys the recording sheet in the lateral direction, and
the second sheet conveyance path comprises a path from the manual sheet feeding unit to the image forming unit, which is a straight line or has a larger curvature radium than a maximum curvature radium of the first sheet conveyance path.

14. The image forming apparatus according to claim 12, wherein:
the sheet feeding unit is disposed below the image forming unit,
the first sheet conveyance path conveys the recording sheet upward along one side surface of the main body of the image forming apparatus, and then changes a conveyance direction of the recording sheet to a side surface opposite to the one side surface,
the image forming unit forms the image on an upper surface of the recording sheet being conveyed in a lateral direction,
the second sheet conveyance path is merged from above into a portion of the first sheet conveyance path where the first sheet conveyance path conveys the recording sheet in the lateral direction, and
the second sheet conveyance path comprises a path from the manual sheet feeding unit to the image forming unit, which is a straight line or has a larger curvature radium than a maximum curvature radium of the first sheet conveyance path.

15. An image forming apparatus comprising:
a manual sheet feeding unit disposed at a position where recording sheets can be placed on the manual sheet feeding unit from an outside of the image forming apparatus directly, the manual sheet feeding unit feeding the placed recording sheets one by one;
wherein the manual sheet feeding unit comprises a tray on which the recording sheets are stacked, the tray protruding from a main body of the image forming apparatus toward an outside of the main body;
an image forming unit that forms an image on a recording sheet supplied from the manual sheet feeding unit;
a sheet conveyance path that conveys the recording sheet from the manual sheet feeding unit to the image forming unit; and
an air-blowing unit that is disposed on the sheet conveyance path and blows air to an edge of the recording sheets stacked on the manual sheet feeding unit.

16. The image forming apparatus according to claim 1, wherein:
at least a part of an operation position of the manual sheet feeding unit is outside the main body of the image forming apparatus.

17. The image forming apparatus according to claim 6, wherein:
at least a part of an operation position of the manual sheet feeding unit is outside the main body of the image forming apparatus.

18. The image forming apparatus according to claim 11, wherein:
at least a part of an operation position of the manual sheet feeding unit is outside the main body of the image forming apparatus.

19. The image forming apparatus according to claim 15, wherein:
at least a part of an operation position of the manual sheet feeding unit is outside the main body of the image forming apparatus.
